(19) United States
(12) Patent Application Publication
(10) Pub. No.: US 2020/0325669 A1
(43) Pub. Date: Oct. 15, 2020

(54) BASE FOR UNIVERSAL SLIDE STYLE FLOAT AND ASSEMBLY1

(71) Applicant: Kevin J. Guthrie, Wind Lake, WI (US)

(72) Inventor: Kevin J. Guthrie, Wind Lake, WI (US)

(21) Appl. No.: 16/844,093

(22) Filed: Apr. 9, 2020

Related U.S. Application Data
(60) Provisional application No. 62/831,389, filed on Apr. 9, 2019.

(51) Int. Cl. E03D 1/33

(52) U.S. Cl. CPC E03D 1/33; F16K 33/00

(57) ABSTRACT

A float comprises an outer float wall, an inner guide, and a float base. The float base further comprises an outer perimeter and a disk-like portion. The disk-like portion includes a central aperture to allow the float base to move with respect to a sleeve. A plurality of apertures are formed within the disk-like structure. In addition, a structure is formed within the float base to allow the float base to be captured within a bottom portion of the float at a fastening structure.

### PRIORITY CLAIM

This application claims priority to U.S. Provisional Patent Application No. 62/831,389, filed Apr. 9, 2019, the contents of which are hereby incorporated by reference.

### FIELD OF THE INVENTION

The present invention relates generally to indoor plumbing and gravity-operated flush toilets. The present invention also relates generally to flush valves of the type having a hollow slide float that controls operation of the valve during a flush cycle. More particularly, the present invention relates to a base for use with a slide style float. The float base has openings defined within it to selectively control the closure timing of the valve. The base openings can assume a number of configurations.

### BACKGROUND OF THE INVENTION

Conventional gravity-operated flush toilets have several basic components. The porcelain or china components include a bowl and a water tank mounted on top of a rear portion of the bowl. The bowl and tank can be separate pieces that are bolted together to form a two-piece toilet. Other gravity-operated flush toilets are made as a one-piece toilet, in which the bowl and tank are made as one continuous, integral piece of china.

More importantly, the plumbing components of a gravity-operated flush toilet include a fill valve in the tank, which is connected to a water supply line, a flush valve surrounding a drain hole in the bottom of the tank that communicates with the bowl, and a flapper valve that normally closes and seals the flush valve or, more precisely, the main flush valve orifice.

In the prior art, one particular type of flush valve has a dedicated float that mounts onto a main seal. When the trip lever is depressed, the float is raised along a float guide and the seal unseats to allow water to flow from the tank to the bowl. The goal of the structure of these flush valves is to maximize water flow efficiency and timing while simultaneously minimizing water wastage.

In the float described herein, the float is generally filled with air. When water enters the float, the float air volume is evacuated or displaced. This makes it an “open float” design. Further, one or more small holes or apertures can be made in the float. When the float is pulled upwardly during a flush cycle, water in the tank can flow through the holes or apertures and into the interior of the float. This increases the overall mass of the float, causing it to sink at an increased rate so as to shorten the closure time of the valve. The size and quantity of the openings can be selected to achieve a closure rate that corresponds to a desired water consumption. In flush valves of this type and of current manufacture, the openings are non-adjustable as made by the original equipment manufacturer (OEM) float to optimize performance for that particular flush valve. This prevents the end user from making any adjustment to the float holes or apertures. This is a particularly problematic situation where a replacement flush valve is chosen by the user because there is virtually no interchangeability between the floats and the apertures or holes defined in them. That is, use of a float that is configured for one flush valve will not function optimally when used in another flush valve. Further, at a retail level, a retailer is required to carry a great multitude of flush valves, since each flush valve has its specific float and float opening requirements. This creates a substantial overstocking and inventory problem.

In view of the foregoing, there is a need for a singular float having flow adjustment means that can be used within a wide variety of flush valves. There is further a need for a bottom wall float structure that allows a user to replace the bottom wall of the float with a bottom wall having a variety of ways to adjust the flow capacity that optimizes performance of the flush valve. The float bases that are configured in accordance with the present invention fulfill this need.

### SUMMARY OF THE INVENTION

In view of the foregoing, a primary objective of the device of the present disclosure is to provide a new, useful, and non-obvious float base that allows for variability in settings so as to maximize flow capacity of the float. The float base of the present disclosure may be used as an OEM part of a flush valve assembly or as a stand-alone replacement for a float of the type described above. As an after-market replacement, the float base of the present disclosure allows for custom flow settings, depending on the flush valve model originally provided, while also eliminating the need to create a substantially larger number of pre-customized replacement parts for purchase by the consumer.

The foregoing and other features of the float base of the present disclosure will be apparent from the detailed description that follows.

### BRIEF DESCRIPTION OF THE DRAWINGS

FIG. 1 is a partially sectioned and perspective view of a toilet tank of the type in which the float base of a float that is part of a flush valve is constructed consistent with the present disclosure.

FIG. 2 is a side elevation view of the flush valve used in the toilet tank shown in FIG. 1 and illustrating the flush valve in a “closed” or water no-flow position.

FIG. 3 is an enlarged front perspective and exploded view of the lower portion of the flush valve float shown in FIG. 2 illustrating a first embodiment of a float base used with the float.

FIG. 4 is a greatly enlarged top and front perspective view of a plug that is used in a first embodiment of the float base shown in FIG. 3.

FIG. 5 is a top plan view of the float and float base taken along line 5-5 of FIG. 2.

FIG. 6 is an enlarged cross-sectioned view of the float and float base taken along line 6-6 of FIG. 5 and showing a plug that is inserted into an aperture defined in the float base.

FIG. 7 is a view similar to FIG. 6 but showing the plug prior to insertion into the aperture defined in the float base.

FIG. 8 is a bottom plan view of the float and a second embodiment of a float base and further illustrating all apertures defined in the float base as being open.

FIG. 9 is a view similar to FIG. 8 but showing all apertures being closed.

FIG. 10A is an enlarged cross-sectioned view of the float base and cover, with the cover shown in the open position, taken along line 10A-10A of FIG. 8.

FIG. 10B is a view similar to that shown in FIG. 10A but showing the cover in the closed position, taken along line 10B-10B of FIG. 9.

FIG. 11 is an exploded front and bottom view of a third embodiment of a float base consistent with the present disclosure.

FIG. 12 is a bottom plan view of the float base shown in FIG. 11 with the rotatable portion of the base shown in a first position.

FIG. 13 is a bottom plan view of the float base shown in FIG. 11 with the rotatable portion of the base shown in a second position.

FIG. 14 is a bottom plan view of the float base shown in FIG. 11 with the rotatable portion of the base shown in a third position.

FIG. 15 is a bottom plan view of the float base shown in FIG. 11 with the rotatable portion of the base shown in a fourth position.

### DETAILED DESCRIPTION

Referring now to the drawings in detail, wherein like-numbered elements refer to like elements throughout, FIG. 1 shows an environment within which the float base is used. Specifically, a gravity-operated flush toilet assembly 1 is provided. The gravity-operated flush toilet assembly 1 comprises a water tank 4 mounted on top of a rear portion of a bowl (not shown) and a water tank cover (partially shown). Water from tank 4 empties into the bowl when a flush lever 8 is pushed downwardly and the flush valve, generally identified 10, is actuated via a linkage between the lever 8 and the flush valve 10. These elements are well-known in the art.

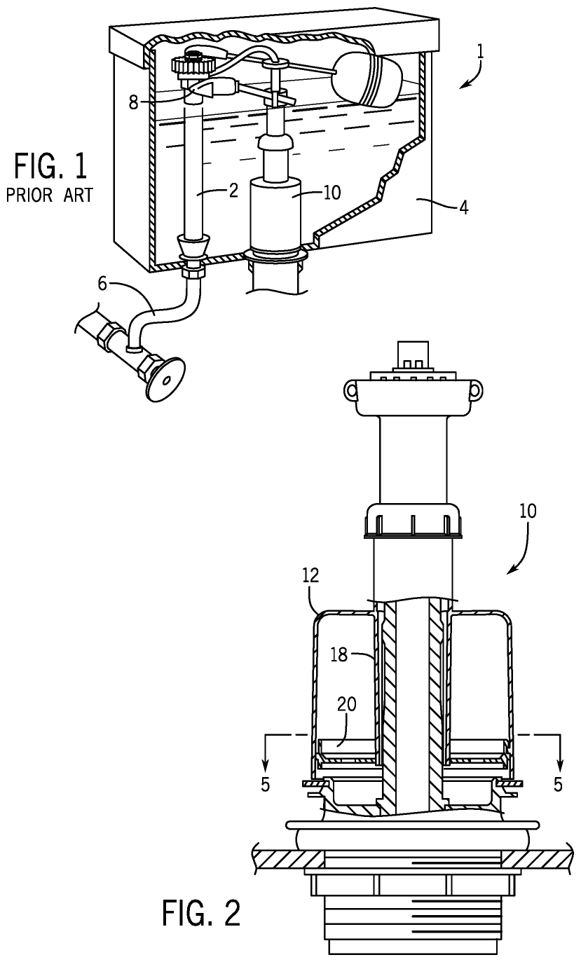

FIGS. 2 through 7 show the details of a first embodiment of a float base, generally identified 20, consistent with the present disclosure. The float base 20 is used with the open float 12 of a flush valve 10 of the type used in the tank 4, illustrated in FIG. 1. As best shown in the cut-away view illustrated in FIG. 3, the float 12, which is an open float, comprises an inner sleeve or guide 18. The guide 18 comprises a float vent slot 19, which forms part of the water flow continuum through the flush valve 10. The float 12 further comprises an outer float wall 14 having an inner surface 13 and an outer surface 15. The bottom 16 of the float wall 14 is substantially circular, but is not limited to that shape, nor is the float 12. The inner surface 13 of the float wall 14 includes a bayonet-type fastening structure 17. Further shown, the bottom 16 of the float 12 is open. The void created at this bottom opening is filled by the float base 20, as will be apparent from this detailed description.

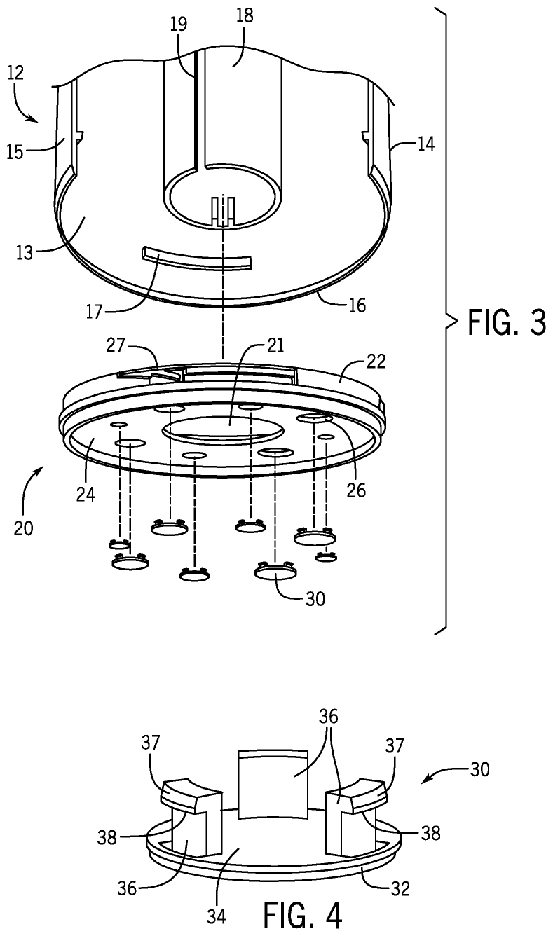

Continuing with FIG. 3, the float base 20 comprises a substantially circular structure. The float base 20 is not limited to that shape, however; instead, the float base 20 should substantially match the shape of the bottom 16 of the float wall 14, as the two structures are intended to be coupled together, as will be discussed further herein. The float base 20 comprises an outer perimeter 22 and a centrally-disposed and substantially flat disk-like portion 24 that lays fully within the confines of the outer perimeter 22. The central disk-like portion 24 has a uniform thickness and, in application, is disposed in a substantially horizontal position. As shown, the disk-like portion 24 comprises a centrally-disposed aperture 21 that is sized to allow movement of the float base 20 along a sleeve (not shown) of the flush valve 10. Also formed within the disk-like portion 24 is a plurality of differently-sized and substantially circular plug-receiving apertures 26. Each aperture 26 comprises an aperture perimeter 28 and an aperture perimeter edge or corner 29. See FIG. 7. Each such aperture 26 is sized to accept a complementary plug, generally identified 30, of the type shown in FIG. 4. Lastly, the float base 20 comprises a complementary structure 27 that allows the float base 20 to be captured within the bottom of the float via the bayonet-type fastening structure 17 of the float 12. It is to be understood, however, that this is not the only way in which the float base 20 and the float 12 can be coupled together.

As shown in FIG. 4, each plug 30 comprises a substantially flat bottom portion 32. The flat bottom portion 32 further has a substantially flat top surface 34. Extending upwardly from this top surface 34 is a plurality of fingers 36. Each finger 36 comprises an upper angled outer edge 37 and an outwardly-extending lip 38. The lip 38 is intended to lay in a substantially horizontal plane. Further, the distance from the top surface 34 of the plug 30, which also lays in a substantially horizontal plane, to the lip 38 substantially matches the thickness of the disk-like portion 24 of the float base 20.

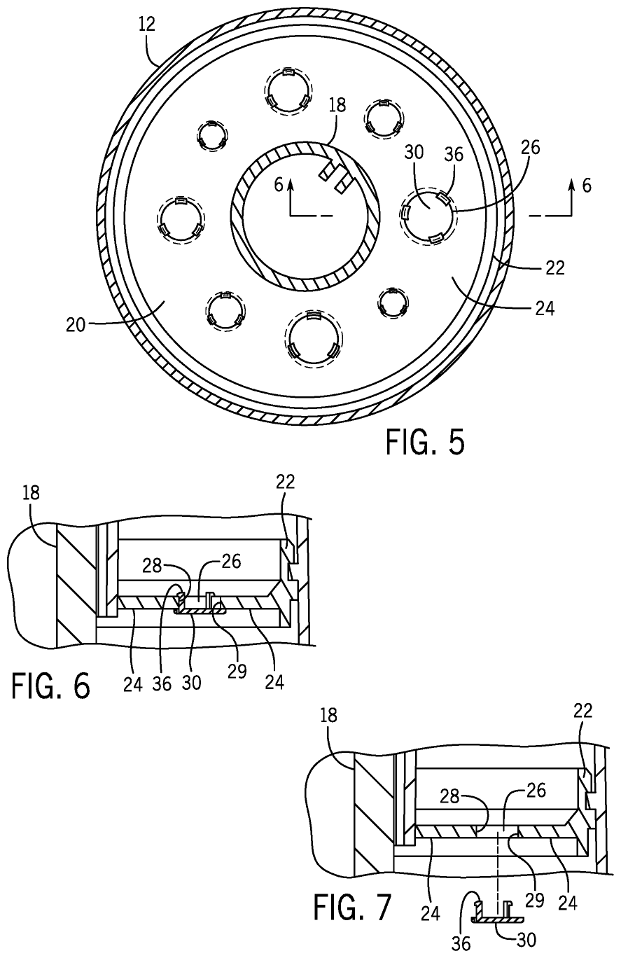

Each plug 30 is comprised of a material that has some elasticity and memory to it. That is, each plug 30 is constructed of a material that allows the fingers 36 of the plug 30 to be pushed or flexed inwardly and then return substantially to a pre-flexed position. In this way, the fingers 36 can be pushed into contact with the corresponding perimeter edge 29 of a correspondingly-sized plug-receiving aperture 26 of the float base 20. As the plug 30 is urged upwardly, an angled outer edge 37 of the finger 36 engages the edge 29 of the aperture perimeter 28, which, in turn, pushes each finger 36 inwardly. Once the fingers 36 are pushed inwardly a sufficient distance (i.e., a distance equal to the thickness of the disk-like portion 24), the outwardly-extending lip 38 of each finger 36 catches the edge 29 of the aperture perimeter 28. This is accomplished by the lip 38 returning to its pre-flexed position, thereby capturing the plug 30 within one of the plurality of differently-sized and substantially circular plug receiving apertures 26. The size of the aperture 26 and the corresponding plug 30 is a function of the floatation parameters required for the particular flush valve 10 and its float 12. See FIGS. 5-7 relative to insertion of a number of plugs 30 into a corresponding aperture 26. That is, the end user can add or subtract plugs 36 as required by the particular flush valve 10 being used. In use, the open apertures 26 of the float base 20 are used to meter water flow, as well as air flow, through the vertical slot 19.

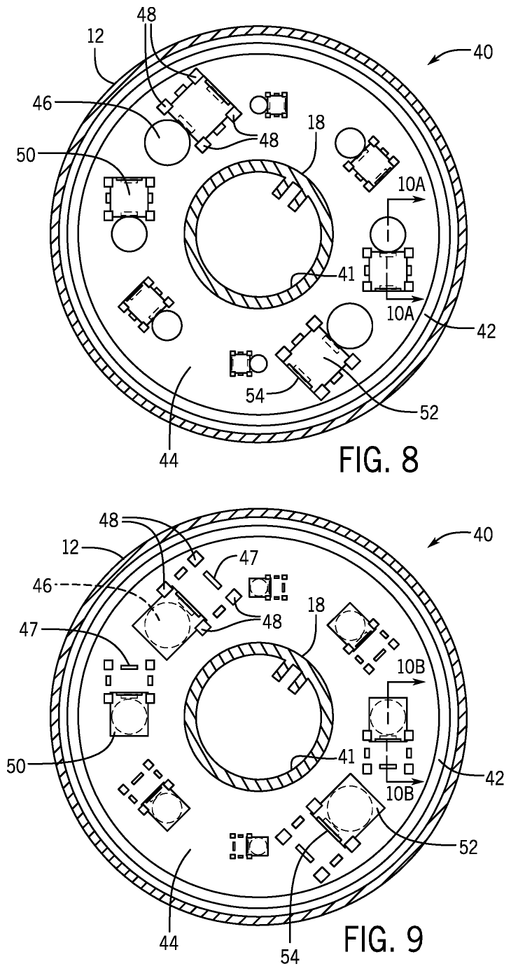

FIGS. 8, 9, 10A, and 10B illustrate a second embodiment of the float base, generally identified 40. FIGS. 8 and 9 are bottom plan views of the same base 40. Much like the first embodiment, the float base 40 comprises an outer perimeter 42 and a centrally-disposed and substantially flat disk-like portion 44 that extends fully within the confines of the outer perimeter 42. The central disk-like portion 44 has a uniform thickness; however, the particular thickness of the central disk-like portion 44 does not significantly impact the functionality of the float base 40 (unlike with the first embodiment described previously). As shown, the disk-like portion 44 further comprises a centrally-disposed aperture 41. The aperture 41 is sized to allow movement of the float base 40 along a sleeve (not shown) of the flush valve 10.

A plurality of differently-sized apertures 46 are also formed within disk-like portion 44. Although the apertures 46 are substantially circular in FIGS. 8 and 9, examples are not so limited, and the apertures 46 may be any shape. Adjacent to each aperture 46 is a capturing structure. The capturing structure comprises a plurality of alignment fingers 48 positioned along each aperture 46 such that a slide cover, generally identified 50, is guided and captured within the alignment fingers 48. A pair of receivers 47 is formed near each set of alignment fingers 48.

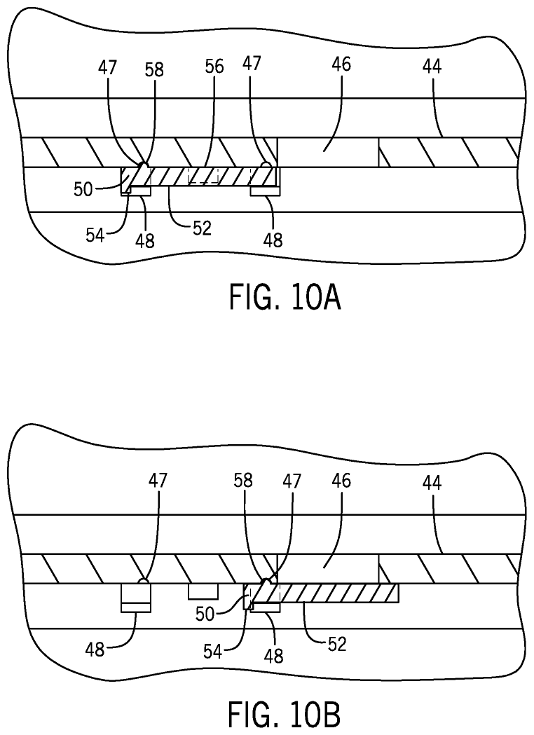

Each cover 50 comprises a flat body portion 52 and a downwardly-extending lip 54. See also FIGS. 10A and 10B. A user can use the lip 54 to push any of the slide covers 50 over an adjacent aperture 46. Here again, the size of the aperture 46 and the corresponding slide cover 50 is a function of the floatation parameters desired or required by a particular flush valve 10 and its float 12. As with the first embodiment, the end user can open or close off any combination of apertures 46 by moving the slide covers 50 as required by the particular flush valve 10 being used. In use, the open apertures 46 of the float base 20 are used to meter water flow, as well as air flow, through the vertical slot 19.

Each slide cover 50 is held in either the open or close position by engagement of a detent 58 that is defined within the upper surface 56 of the cover 50. The slide cover 50 can be held in either position by engagement of the detent 58 with one of the receivers 47. For covering an aperture 46, the detent 58 engages the receiver 47 closest to the aperture 46. For uncovering an aperture 46, or keeping it open to water flow, the detent 58 engages the receiver 47 that is furthest away from the aperture 46. In either instance, the engagement by the detent with a receiver 47 allows for the slide cover 50 to remain in its open or closed position, as required by the functional requirements of the particular float 12 being used.

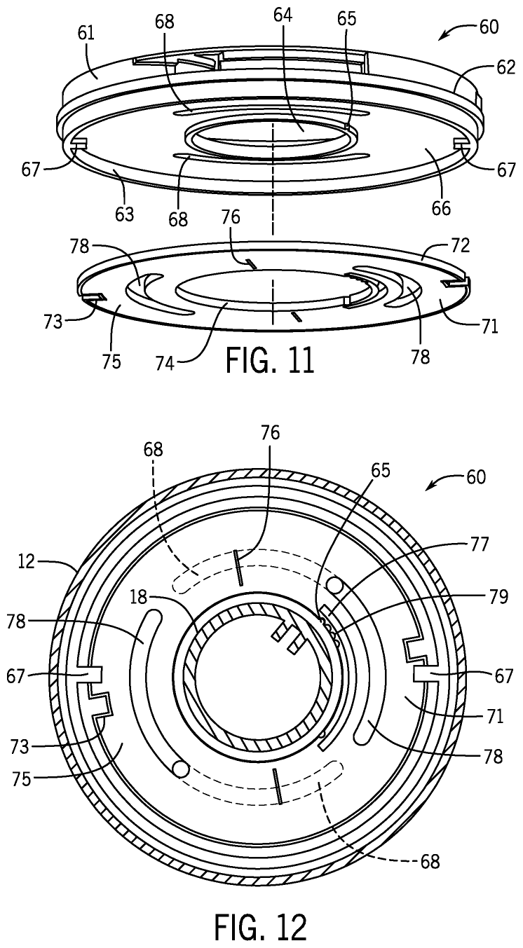

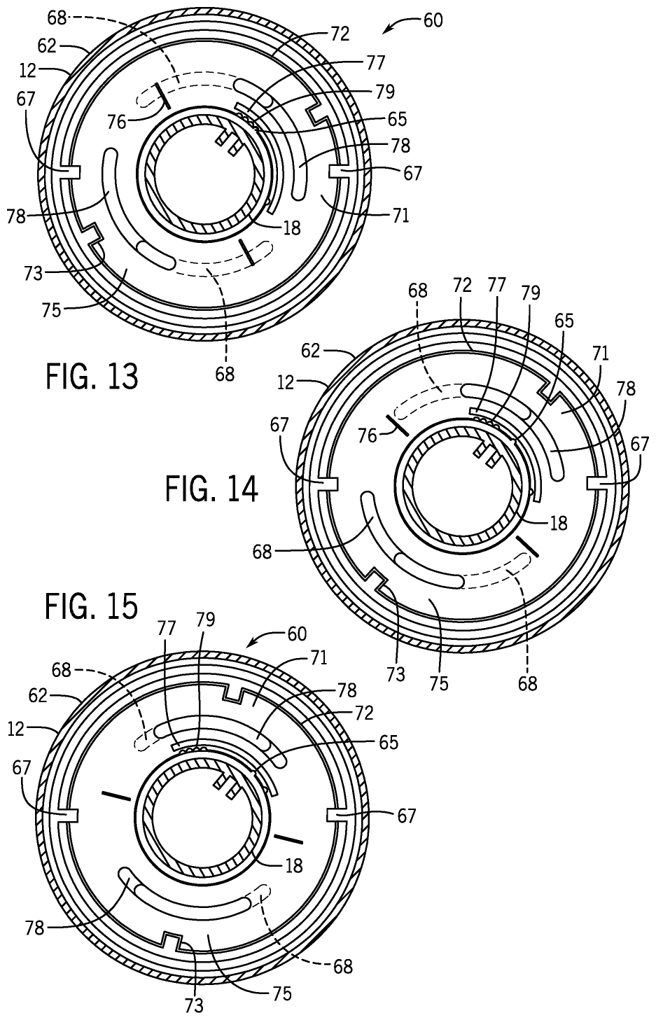

FIGS. 11-15 illustrate a third embodiment in which a dial adjustable portion is utilized. More particularly, the float base, generally identified 60, is comprised of a first base member 61; the first base member 61 comprises an outer perimeter 62, an inner perimeter 63, and a centrally-disposed and substantially flat disk-like portion 66, which extends fully within the confines between the outer perimeter 62, the inner perimeter 64, and a bottom face 63. A second base member or “adjuster” 71 is also provided. The central disk-like portion 66 of the first base member 61 has a uniform thickness; however, the particular thickness of the portion 66 does not significantly impact the functionality of the float base 60.

The outer perimeter 62 further comprises a pair of inwardly-projection and opposing retention tabs 67, which form a capture structure. Although two retention tabs 67 are shown, examples are not so limited and other numbers of retention tabs 67 may be used. In addition, a positioning tab 65 extends outwardly from the inner perimeter 64. Two opposing radial openings 68 are also formed within the disk-like portion 66.

Float base 60 uses a combination of the first base member 61 and the second base member 71 to meter water flow, as well as air flow, through the vertical slot 19 (as with float bases 20, 40, discussed with respect to FIGS. 1-10B). The second base member 71 comprises a top surface 73 and a bottom surface 75. The top surface 73 is intended to be placed adjacent to the bottom face 63 of the first base member 61 when the second base member 71 is held in place by the retention tabs 67.

The second base member 71 includes an outer perimeter 72 and an inner perimeter 74. In this embodiment, outer perimeter 72 is a stand-off rib and further comprises a pair of opposing slots 73. Slots 73 allow the second base member 71 to be placed adjacent to the first base member 61 via the retention tabs 67, which then allows the second base member 71 to be rotated. That is, the second base member 71 is installed when the slots 73 line up with the retention tabs 67.

The second base member 71 further comprises two opposing radial openings 78. Radial openings 78 are similarly sized and positioned to overlay, or to partially overlay, the radial openings 68 of the first base member 61. Moreover, the second base member 71 includes a pair of ridges 76 at the bottom surface 75; the ridges 76 allow the user to rotate the second base member 71 to a required position. Further, the second base member 71 has a third arcuate slot 77. Arcuate slot 77 effectively provides a spring that allows the positioning tab 65 to selectively engage positioning openings 79 that are disposed along the inner perimeter 74. When the positioning tab 65 engages with positioning openings 79, arcuate slot 77 adds a small amount of side load force. The positioning openings 79 may be numbered or lettered to match specific settings for different brands and/or models of toilets.

In the foregoing detailed description of the present disclosure, reference is made to the accompanying drawings that form a part hereof, and in which are shown by way of illustration how examples of the disclosure may be practiced. These examples are described in sufficient detail to enable those of ordinary skill in the art to practice the examples of this disclosure, and it is to be understood that other examples may be utilized and that process and/or structural changes may be made without departing from the scope of the present disclosure.

The elements shown in the various figures herein can be added, exchanged, and/or eliminated so as to provide a number of additional examples of the present disclosure. In addition, the proportion and relative scale of the elements provided in the figures are intended to illustrate the examples of the present disclosure and should not be taken in a limiting sense.

1. A float base, comprising:
a first base member, the first base member further comprising:
an outer perimeter, wherein the outer perimeter further comprises at least one retention tab;
an inner perimeter, wherein the inner perimeter further includes at least one positioning tab;
a bottom face; and
a disk-like portion, wherein:
the disk-like portion extends within the confines between the outer perimeter and the inner perimeter; and
at least one radial opening disposed within the disk-like portion; and
a second base member, wherein the second base member further comprises:
a top surface, wherein the top surface is placed adjacent the bottom face of the first base member;
a disk-like portion, wherein the disk-like portion includes at least one water flow adjustment arc and at least one positioning arc.

2. The float base of claim 1, wherein the first and second base members are retained in position via retention tabs disposed within the float base.

3. The float base of claim 2, wherein the second base member is rotatable with respect to the first base member when the second base member is engaged with the first base member.

4. The float base of claim 3, wherein the at least one positioning arc comprises a plurality of ridges that allow selective positioning of the second base member.

5. The float base member of claim 4, further comprising at least one tab that engages the plurality of ridges of the at least one positioning arc.

6. The float base of claim 2, wherein the at least one water flow adjustment arc of the second base member are sized and positioned to overlay the at least one radial opening of the first base member.

7. A float base, comprising:
an outer perimeter; and
a disk-like portion, wherein the disk-like portion further comprises:
a central aperture, wherein the central aperture is sized to allow movement of the float base along a sleeve of a flush valve;
a plurality of apertures;
a plurality of capturing structures, wherein:
each capturing structure of the plurality of capturing structures is disposed adjacent to an aperture of the plurality of apertures; and
each capturing structure comprises a plurality of alignment fingers to receive a slide cover.

8. The float base of claim 7, wherein:
the disk-like portion has a uniform thickness; and
the disk-like portion extends within the confines of the outer perimeter.

9. The float base of claim 7, wherein:
each aperture of the plurality of apertures is a different size; and
the size of each aperture of the plurality of apertures corresponds to a particular floatation parameter.

10. The float base of claim 7, wherein the slide cover further comprises:
a flat body portion;
a downwardly extending lip; and
a detent to engage with a receiver, wherein engagement of the detent holds the slide cover in position.

11. The float base of claim 10, wherein:
the slide cover engages a receiver closest to an aperture to close the aperture; and
the slide cover engages a receiver furthest from the aperture to open the aperture.

12. A float, comprising:
an outer float wall, wherein the float wall further comprises:
an outer surface; and
an inner surface, wherein the inner surface further comprises a fastening structure;
an inner guide, wherein the inner guide further includes a float vent slot; and
a float base, wherein the float base further comprises:
an outer perimeter; and
a disk-like portion, wherein the disk-like portion further comprises:
a central aperture, wherein the central aperture is sized such that the float base is movable with respect to a sleeve;
a plurality of apertures; and
a complementary structure to allow the float base to be captured within a bottom portion of the float at the fastening structure.

13. The float of claim 12, further comprising a plurality of plugs, wherein:
each plug further comprises:
a top surface; and
a plurality of fingers extending upwardly from the top surface, wherein each finger further comprises:
an upper angled outer edge; and
an outwardly-extending lip; and
each plug is sized to be received by an aperture of the plurality of apertures in the float base.

14. The float of claim 12, wherein:
the disk-like portion lays within the confines of the outer perimeter; and
the disk-like portion is disposed in a horizontal position.

15. The float of claim 12, wherein the disk-like portion has a uniform thickness.

16. The float of claim 12, wherein:
each aperture of the plurality of apertures further comprises:
an aperture perimeter; and
an aperture perimeter edge; and
each aperture of the plurality of apertures has a different aperture perimeter.

17. The float of claim 12, wherein the open apertures of the float base are used to meter water through the float vent slot.
